(19) United States
(12) Patent Application Publication
(10) Pub. No.: US 2014/0297498 A1
(43) Pub. Date: Oct. 2, 2014

(54) Broker Commission Allocation System

(71) Applicant: BLOOMBERG L.P., New York, NY (US)

(72) Inventor: Gary Stone, Great Neck, NY (US)

(21) Appl. No.: 13/855,382

(22) Filed: Apr. 2, 2013

(51) Int. Cl. G06Q 20/06

(52) U.S. Cl. CPC G06Q 20/06; G06Q 40/04
USPC 705/37

(57) ABSTRACT

Methods and systems for allocating trades to multiple brokers are disclosed. An execution algorithm for an order is selected. A weighting allocation is for the order to brokers is specified. The order is allocated based on the weighting allocation and execution algorithm. The order is subsequently transmitted for execution.

### BACKGROUND

Typically, buy side execution decisions are made based on selecting an appropriate algorithm and also taking into account a commission budget. For example, a broker may be selected based on a commission budget which may take into account factors such as who needs to be paid for providing the services (research, access to analysts, capital markets, corporate access, etc.) and when they are to be paid. A buy or sell side execution algorithm may be selected based on several factors such as comfort, familiarity, liquidity considerations, and opportunities to minimize market impact and information leakage.

Presently, in order to route orders of a trade to several brokers, each order must be split and entered or processed manually. This process is painstaking and also disjointed as one must constantly keep track of each individual order that may be associated with other orders sent to different brokers. As each order must be carried out manually, multiple individual orders must be employed whenever a buy or sell side execution decision involving more than one broker is made. Furthermore, using current solutions, there is no facilitation of a direct link between a buy side trader to execute, allocate, and settle directly with a broker of their choice.

Using single direct market access (DMA) is limiting as these orders may only be allocated to one broker at a time. This involves a sometimes lengthy manual process where each different order to each different broker's smart order routers (SOR) must be carried out individually. DMA orders do not allow for allocation of orders to groups of brokers.

It is thus desirable to have an allocation order management system for efficiently allocating orders from a buy side client to brokers to execute trades.

### SUMMARY

Embodiments of the present disclosure allows buy side traders or clients to utilize a single set of algorithms to effectively trade with multiple brokers by allowing selection of an execution algorithm for a trade order and leveraging multiple brokers by way of weighted allocations to the brokers to execute trades and allocate commissions. A single set of order type may be utilized to execute orders with multiple brokers, as well as allow multiple brokers to be paid on a single order.

In accordance with an embodiment of the present disclosure, an execution algorithm for an order is selected. A weighting allocation for the order to at least one broker is specified. The order is allocated based on the weighting allocation and execution algorithm. The order is subsequently transmitted for execution.

In accordance with an embodiment of the present disclosure, the execution algorithm may be selected by determining at least one algorithm based on the order, and receiving a selection of the execution algorithm from the at least one algorithm. The execution algorithm may also be selected by determining at least one algorithm based on the order; and dynamically selecting the execution algorithm from the at least one algorithm.

In accordance with an embodiment of the present disclosure, in order to allocate the order, the order is split into child orders, wherein each child order is associated with a respective broker.

In accordance with an embodiment of the present disclosure, the order is transmitted for execution as a single order by transmitting the order comprising a plurality of child orders to the at least one broker for execution. Each of the plurality of child orders is associated with a respective broker instructing the respective broker to execute a portion of the order based on the weighting allocation. The order may also be transmitted for execution as a single order by transmitting the order comprising a plurality of child orders to an exchange for execution on behalf of each respective broker associated with each of the plurality of child orders based on the weighting allocation. The exchange may alternately carry out the order and notify the broker via a message included in a child order specifying the portion for the order allocated to the particular broker.

In accordance with an embodiment of the present disclosure, the order may be automatically allocated. A commission budget is processed. A portion of the order may be automatically allocated to each corresponding broker based on the processed commission budget. Automated orders may be implemented for execution based on the automatic allocation.

The embodiments described herein may furthermore be carried out on a computing device that performs operations based on execution of non-transitory computer readable medium having executable code stored thereon.

In accordance with an embodiment of the present disclosure, a non-transitory computer readable medium having executable code stored thereon, that when executed, causes a computing device to perform at least the following operations: selecting an execution algorithm for an order; specifying a weighting allocation for the order to at least one broker; allocating the order based on the weighting allocation and execution algorithm; and transmitting the order for execution.

The embodiments described herein may furthermore be carried out on a system comprising at least an allocation management module and a transmission unit. The allocation management module, coupled to a network, may be configured for: selecting an execution algorithm for an order; specifying a weighting allocation for the order to at least one broker; and allocating the order based on the weighting allocation and execution algorithm. The transmission unit, coupled to the allocation management module and the network, may be configured for: transmitting the order for execution.

The aforementioned embodiments and other advantages of the embodiments described herein will be apparent to those of ordinary skill in the art at least by reference to this summary, the following detailed description, and the accompanying drawings.

### BRIEF DESCRIPTION OF THE DRAWINGS

The systems and methods described herein may be better understood with reference to the following drawings and detailed description. Non-limiting and non-exhaustive embodiments are described with reference to the following drawings.

FIG. 1 illustrates a diagram of an exemplary diagram in which the embodiments of the present disclosure may be implemented;

FIG. 2 illustrates an exemplary block diagram showing exemplary interactions between the principal parties in accordance with the embodiments described herein;

FIG. 3 illustrates another exemplary block diagram showing exemplary interactions between the principal parties in accordance with the embodiments described herein;

FIG. 4 illustrates an exemplary block diagram showing an exemplary broker allocation system in accordance with the embodiments described herein;

FIG. 5 illustrates an exemplary flow diagram showing an algorithm in accordance with the embodiments described herein;

FIG. 6 illustrates another exemplary flow diagram showing an algorithm in accordance with the embodiments described herein;

FIG. 7 illustrates another exemplary flow diagram showing an algorithm in accordance with the embodiments described herein;

FIG. 8 illustrates an exemplary user interface for viewing analytics regarding a potential order in accordance with the embodiments described herein;

FIG. 9 illustrates another exemplary user interface for viewing analytics regarding a potential order in accordance with the embodiments described herein;

FIG. 10 illustrates another exemplary user interface for indicating weighting allocations for an order to different brokers in accordance with the embodiments described herein; and

FIG. 11 illustrates a high-level diagram of a computing device that may be used to implement various aspects of the present disclosure.

### DETAILED DESCRIPTION

Detailed embodiments of the present disclosure are provided herein. Any and all disclosed embodiments are merely exemplary and may be embodied in various and alternative forms, and combinations thereof. As used herein, “exemplary,” and similar terms, may refer expansively to embodiments that serve as an illustration, specimen, model, or pattern. The figures may include exaggerated or minimized features, in order to adequately show details of particular components. In certain instances, well-known components, systems, materials or methods that have not been described in detail in order to avoid obscuring from the focus of the present disclosure. Therefore, specific structural and functional details disclosed herein are in no way to be interpreted as limiting, but merely as a basis for the claims and as a representative basis recognizable to one skilled in the art to employ the present disclosure.

While the detailed description may include a general context of computer-executable instructions, the present disclosure may be implemented in combination with other program modules and/or as a combination of hardware and software. Thus, terms such as “computer” or “computing device” as used herein are expansive and are meant to include routines, program modules, programs, components, data structures, algorithms, and the like. Various systems may also be used for the implementation of the embodiments described herein, including single processor or multi-processor systems, minicomputers, mainframe computers, personal computers, hand-held computing devices, microprocessor-based computers, programmable consumer electronics, in-vehicle computing devices, and any of the aforementioned combinations thereof; and the like.

In various embodiments, the present disclosure describes systems and methods for providing a tool allowing buy side clients or sell side clients to trade efficiently and transparently with multiple brokers via a single order. The order may represent a buy or a sell order. The client is provided with broker neutral standard execution algorithms that are used as the basis for allocating order flow through weighted allocations to several brokers for execution of trades. Various analytic tools may be utilized by a client to select an appropriate algorithm for a particular order. The analytic tools would be accessed by the client and based on use of the analytic tools, the client may be provided with a list of appropriate algorithms for the order at hand. Algorithms used for trading orders are utilized to execute pre-programmed trading instructions based on variables such as timing, price, or quantity of the order. One exemplary algorithm is volume-weighted average price (VWAP). Any trading algorithm known in the art may be used in accordance with the embodiments described herein. Alternatively, the algorithm may be automatically selected based on the particular order without input from the client.

Once an algorithm is selected, the client enters an allocation representing what portion of the order should be allocated to each of a group of brokers to execute the trade. The order is allocated into child orders which are then sent to the market or broker in accordance with the allocations for execution based on the execution algorithm. The broker thereafter executes, allocates, settles, and clears the order and is paid a commission directly by the client.

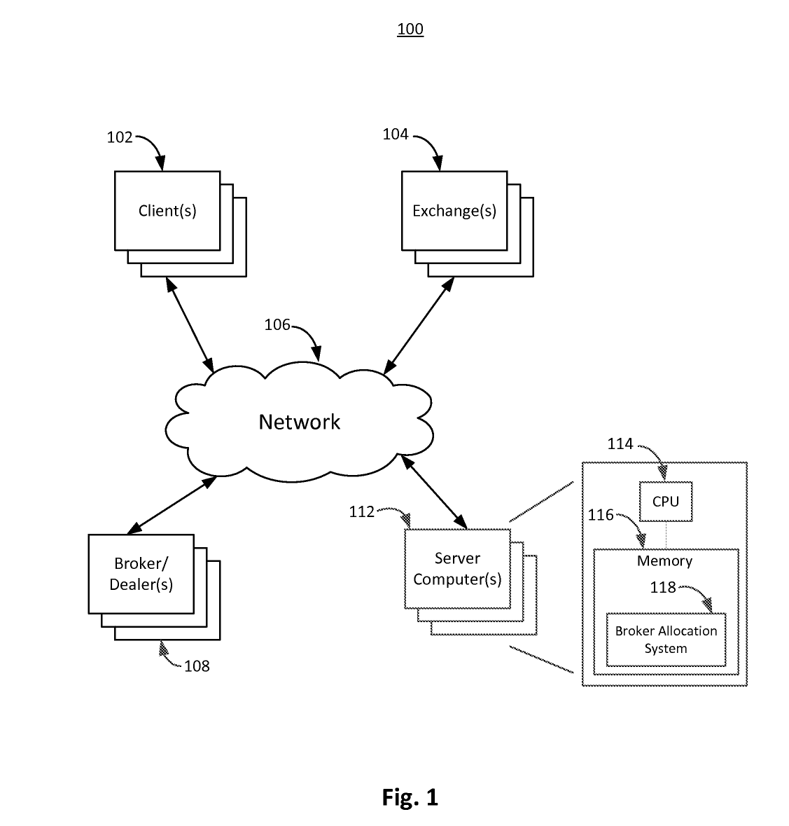

FIG. 1 illustrates a diagram of an exemplary diagram in which the embodiments of the present disclosure may be implemented. More specifically, system 100, as shown in FIG. 1 includes a network 106, and one or more server computers 112, which may, for example, belong to a brokerage firm or technology services provider, may be connected via network 106 to various other computing devices, servers, databases, networks, and the like, such as one or more clients 102 (e.g., money managers, advisers, end-clients, buy side traders, buy side clients, sell side clients, etc.), one or more exchanges 104 (e.g., market exchanges), and one or more third party broker/dealers 108. While these components are shown, they are not all required to practice the various embodiments described herein, and variations or substitutions in the arrangement and type of the components may be made. Server(s) 112 may vary widely in configuration or capabilities, but generally may include, a CPU 114 coupled to memory 116. One or more server computers 112 may also include one or more wired or wireless network interfaces (not shown), one or more input/output interfaces (not shown), or one or more operating systems (not shown), such as Windows Server, Mac OS X, Unix, Linux, FreeBSD, or the like. Memory 116, which may include volatile or non-volatile memory, may have stored thereon a broker allocation system 118 in accordance with the embodiments described herein. Broker allocation system 118 is intended to broadly include all programming, applications, algorithms, software and other tools necessary to implement or facilitate the embodiments described herein. The elements of broker allocation system 118 may furthermore reside or exist on a single server computer or be distributed among multiple server computers or devices. Devices capable of operating as a server may include, as examples, dedicated rack-mounted servers, desktop computers, laptop computers, integrated devices combining various features of the aforementioned computing devices, such as two or more features of the foregoing devices, or the like.

Network 106 is configured to couple network devices with other computing devices. Network 106 is enabled to employ any form of computer readable media for communicating information from one electronic device to another. Also, network 106 may include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. For example, various Internet Protocols (IP), Open Systems Interconnection (OSI) architectures, and/or other communication protocols, architectures, models, and/or standards, may also be employed within network 106. Furthermore, remote computers and other related electronic devices could be remotely connected to either LANs or WANs via a modem and temporary telephone link. In essence, network 106 includes any communication method by which information may travel between computing devices.

In accordance with an embodiment, broker allocation system 118 is configured for selecting an execution algorithm for an order, specifying a weighting allocation for the order to at least one broker, allocating the order based on the weighting allocation and execution algorithm, and transmitting the order for execution. The user order for a trade and user input may be provide by client 102 to broker allocation system 118 via server computer 112. Server computer 112 may provide client 102 with a user interface in order for client 102 to provide the information for the order for the trade as well as user input with regard to execution algorithm selection. A weighting allocation may be specified for the order to at least one broker. The specification is made in response to instructions received at broker allocation system 118 from client 102. The aforementioned user interface allows client 102 to select portions of the order to be assigned to each respective broker. Once the selections are made, the broker allocation system specifies the weighting allocations for the order for each respective broker that will receive the portion of the order and execute the trade. Broker allocation system 118 may then allocate the order to each respective broker based on the weighting allocation and execution algorithm by processing the original order into a plurality of child orders, each associated with a respective broker, and indicating a percentage amount of the order assigned to the respective broker along with information regarding the execution algorithm. The broker allocation system 118 may then transmit the order including child orders, as a single order, either directly to the brokers 108, or to an exchange 104 which will execute the order on behalf of the brokers.

In accordance with an embodiment, broker allocation system 118 may also directly provide for specifying the weighting allocation for the order to at least one broker, allocating the order based on the weighting allocation, and transmitting the order for execution without any selection of an execution algorithm.

In accordance with an embodiment, broker allocation system 118 allocates portions of orders incrementally across all chosen brokers until the order is complete. The incremental ordering is analogous to a wheel arrangement, thus, forming the foundation of a broker commission allocation wheel implementation.

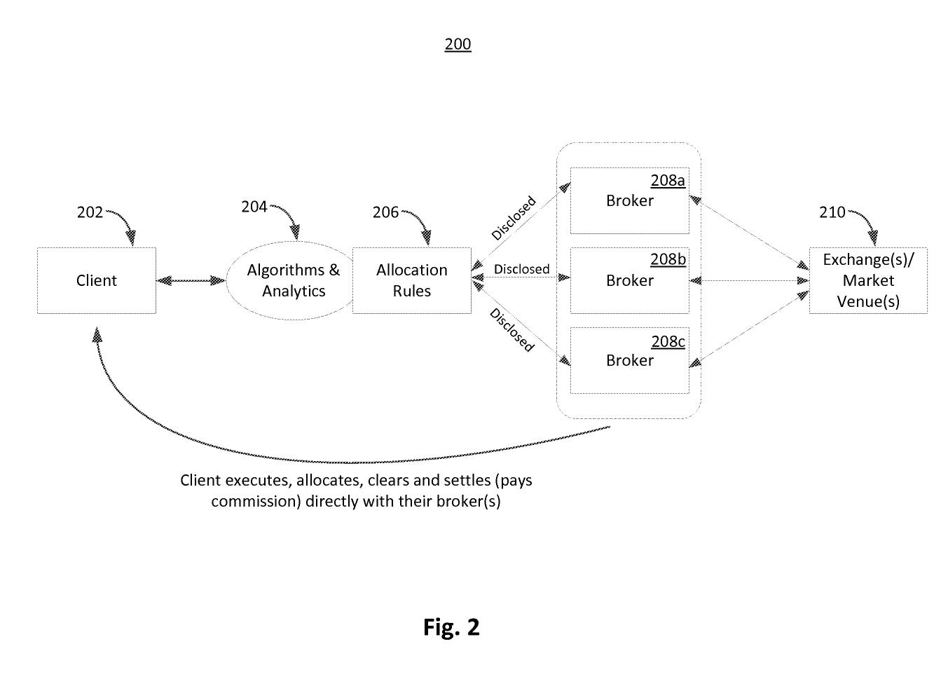

FIG. 2 illustrates an exemplary block diagram showing exemplary interactions between the principal parties in accordance with the embodiments described herein. Block diagram 200 illustrates an execution of a trade by client 202 directly with any of brokers 208a, 208b, and/or 208c. While only three brokers are shown, any number of brokers may be utilized in accordance with any of the embodiments described herein. For example, client 202 may access a user interface provided by a server with a broker allocation system, such as server 112 and broker allocation system 118. Through the user interface, client 202 may decide to place a buy order for 50,000 shares of XYZ stock over the course of a day. Through the user interface, client 202 may elect to run analytics represented by algorithms & analytics 204, in order to determine which execution algorithm to use to instruct a broker to execute the order. For example, client 202 may elect to use a VWAP execution algorithm. Through the user interface, client 202 may further set allocation rules 206 which allow the broker allocation system to specify a weighting allocation for the order to brokers 208a, 208b, and 208c, at the election of client 202. Based on the allocation rules 206, the broker allocation system will create child orders within the original order, where each child order represents a portion of the order for 50,000 shares of XYZ based on the weighting allocation. For example, client 202 may have selected to use all three brokers 208a, 208b, and 208c, and set allocation rules to send 50% of the order to broker 208a, and 25% each to brokers 208b and 208c respectively. Once the allocation is set, the broker allocation system will transmit the order including child orders directly to brokers 208a, 208b, and 208c. Each broker 208a, 208b, and 208c only receives their respective associated child order. Once each respective broker 2081, 208b, or 208c executes their respective child orders, the execution of the orders is reported to exchange 210. As orders may not be transmitted as a lump order, broker allocation system 118 may ensure that orders are executed by the respective brokers in an appropriate proportion determined by the weighting allocation.

While a buy order is described in the aforementioned paragraph, the buy order may also instead be a sell order. Additionally, while the example describes a stock order, the stock order may be substituted by any other asset class.

In an embodiment, client 202 may also be able to upload a commission budget and rules for auto-allocation to stay “on-track” with the commission budget through the user interface. This information may be provided as a part of allocation rules 206 and allows the allocation or orders to different brokers to be further defined to be based on routes or commission to facilitate meeting commission targets. For example, the aforementioned order for a trade of 50,000 shares of XYZ may have a weighting automatically allocated based on commission generated. This also allows multiple brokers to be paid from a single order. It is appreciated that any allocation methodology to split orders across several brokers may be implemented and used.

In an embodiment, transmission of the child orders to each respective broker 208a, 208b, and 208c may also take place over time and be delayed or accelerated as necessary to ensure that a proper ratio is within a predetermined range. For example, in the example above, 50% of the shares are allocated to broker 208a, and 25% to each of brokers 208b and 208c. Thus, the child orders will include instructions to ensure that for every one order executed by brokers 208b and 208c, two orders will be executed by broker 208a to ensure that a proper ratio is always substantially consistent. This not only allows transparency for client 202 in knowing the exact brokers that the orders are being executed by, but also ensures that the client 202 is always providing orders based on the weighting allocation specified so that no one broker is receiving a disproportionate share at any given point in time. Based on the embodiments described herein, either an exchange or 104 or broker allocation system 118 may notify the brokers of the executed orders on behalf of a client. In other words, the order is transmitted on behalf of a sponsoring broker (which would be a member of the exchange) directly to the exchange for execution.

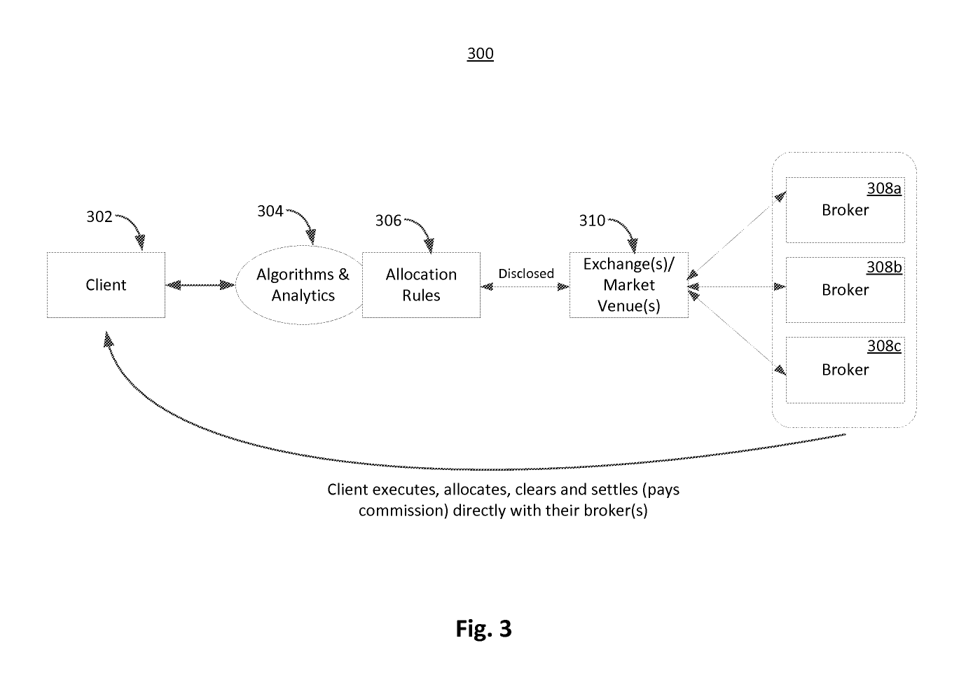

FIG. 3 illustrates another exemplary block diagram showing exemplary interactions between the principal parties in accordance with the embodiments described herein. All blocks shown by block diagram 300 correspond with the blocks shown in block diagram 200. Client 302 corresponds with 202, algorithms & analytics 304 with 204, allocation rules 306 with 206, exchange 310 with 210, and brokers 308a, 308b, and 308c with 208a, 208b, and 208c. The main difference shown by block diagram 300 is the interaction between client 302, exchange 310, and brokers 308a, 308b, and 308c. When client 302 is ready to transmit an order for a trade including child orders to different brokers for execution, instead of the order being transmitted directly to the brokers, the order may be transmitted first to exchange 310. This allows orders to be sent from clients directly to the exchange. Once received at the exchange, each child order will include information that indicates the appropriate broker which is executing a respective portion of the order. The information allows the child orders to be routed to their appropriate associated broker while also ensuring that commissions will be paid directly from the client.

Both block diagrams advantageously show how any given client may utilize a server including a broker allocation system to execute, allocate, clear and settle (pay commission) directly with their brokers, and thus facilitating a system providing both efficiency and transparency.

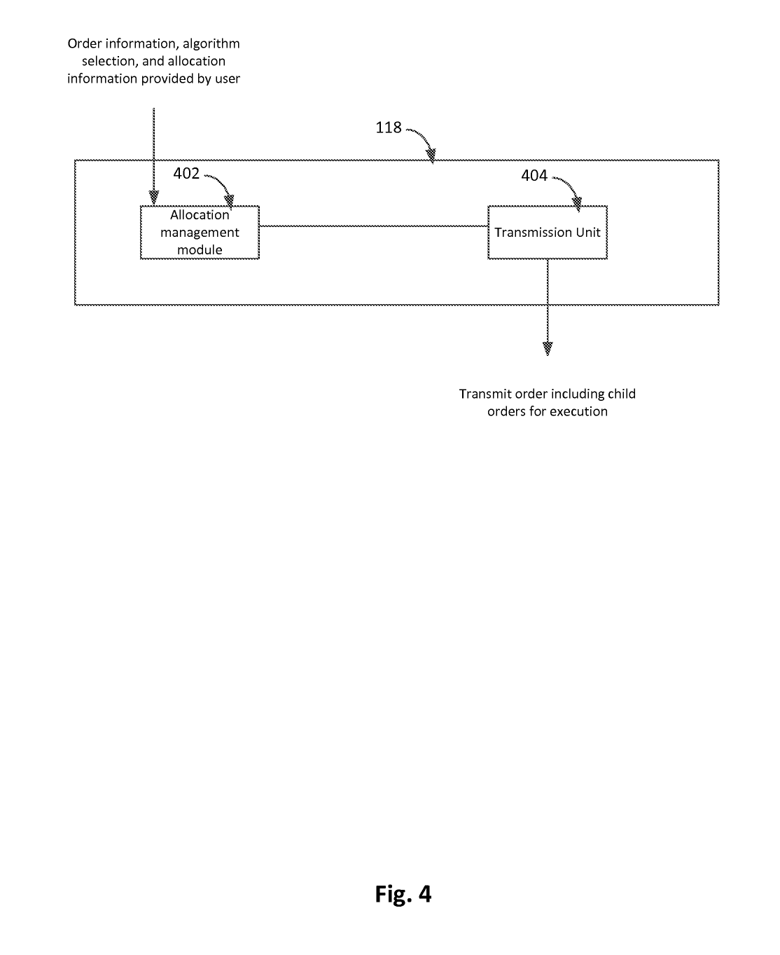

FIG. 4 illustrates an exemplary block diagram showing an exemplary broker allocation system in accordance with the embodiments described herein. Broker allocation system 118 is shown, including allocation management module 402 and transmission unit 404. When a user at a client 102 decides to use broker allocation system 118 via server 112, the user is typically provided a user interface to enter an order for a trade. Through the user interface, the user at client 102 will enter information such as how many shares of a particular equity it wishes to trade. Once this information is entered, the user at client 102 transmits the order information to broker allocation system 118. This order information is received by allocation management module 402. A user of client 102 may also select a strategic analysis option from the user interface in order to be presented with a list of execution algorithms for executing the order. Selection of the strategic analysis option through a user interface results in presentation of a list of execution algorithms deemed suitable for the particular order at hand. When the user of client 102 makes an election of an execution algorithm, information providing an indication of the execution algorithm is transmitted to the allocation management module 402 to select the execution algorithm as the designated execution algorithm for the order. Alternatively, the execution algorithm may be automatically selected by the allocation management module 402 when it receives an order based on analysis of certain factors or variables such as timing, price, or quantity of the order.

The user of client 102 may then enter a list of brokers it wishes to execute the trade, select brokers from a prestored list of brokers to execute the trade, or load a prestored group of brokers to execute the trade in the user interface. Regardless of the selection of an execution algorithm, a user of client 102 may enter a list of brokers to execute the trade. When presented with the list of selected brokers, the user of client 102 may enter a weighting percentage or allocation associated with each broker. The weighting percentage will represent the percentage or allocation of an order that will be allocated to each broker for execution. This information is then provided to allocation management module 402.

While the aforementioned paragraphs describe a particular order for transmitting the information regarding the order, execution algorithm selection, and weighting allocation information to allocation management module 402, the order is meant to be exemplary and is no way limiting. For example, the information regarding the order (such as the amount of shares to be purchased for a particular equity over a given time frame), execution algorithm selection, and weighting allocation, may be transmitted from client 102 to allocation management module 402 via network 106 simultaneously or as individual and discrete components.

Once the order information, execution algorithm selection, and/or weighting allocation information is provided to allocation management module 402, allocation management module 402 uses this information to specify a weighting allocation for the order to at least one broker. In an embodiment, an execution algorithm selection is not needed in order to specify the weighting allocation. The order may then be allocated to each broker based on the weighting allocation and/or execution algorithm. This may involve splitting the order into a plurality of child orders, where each child order is associated with a respective broker. While the order may be split into child orders associated with respective brokers, the order itself still exists as a single order embodying the plurality of child orders. The single order is provided by allocation management module 402 to transmission unit 404. Transmission unit 404 transmits the order including child orders for execution to either the brokers 108 or an exchange 104. Transmission unit 404 transmits the order as a single order representing child orders assigned to multiple brokers, and based on user specified instructions from client 102.

The order comprising child orders may be transmitted to a plurality of brokers 108 for execution. Each of the plurality of child orders is associated with a respective broker instructing the respective broker to execute a portion of the order based on the weighting allocation.

Alternatively, the order comprising child orders may be transmitted directly to an exchange which for routing to each respective broker associated with each of the plurality of child orders to execute a portion of the order based on the weighting allocation.

In an embodiment, the allocation management module 402 may further be configured to process a commission budget, automatically allocate to each of the brokers a portion of the order based on the processed commission budget, and implementing at least one automated order for execution based on the automatic allocation.

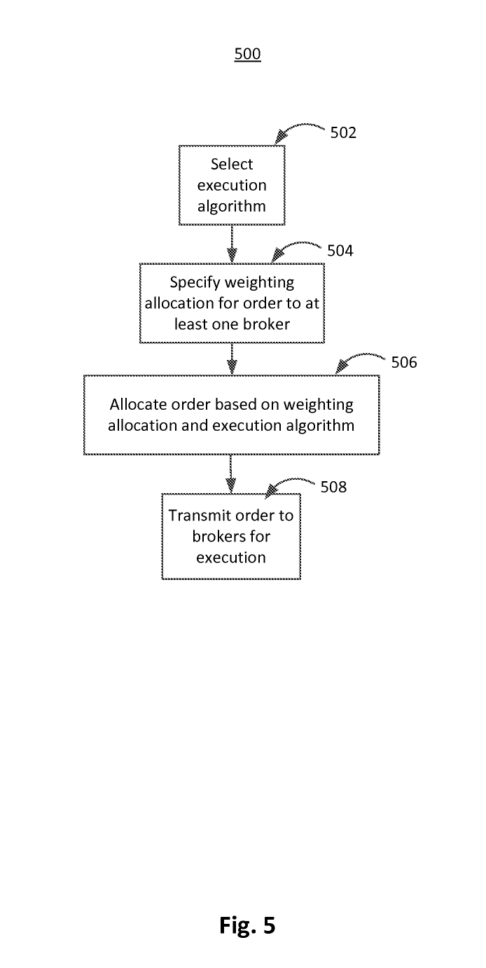

FIG. 5 illustrates an exemplary flow diagram showing an algorithm in accordance with the embodiments described herein. Method 500, as shown, illustrates an algorithm for transmitting a single order to multiple brokers for execution. In an embodiment, a broker allocation system, such as broker allocation system 118 may select an execution algorithm at step 502 based on user input received from a client 102 indicating an order for a trade. Selection of an execution algorithm includes determining at least one algorithm based on order information and variables such as timing, price, or quantity of the order. The algorithms may be provided in a list to a user of client 102 through a user interface provided by server 112. Upon receiving a selection of the execution algorithm from the list of algorithms from client 102, broker allocation system 118 then indicates or flags that execution algorithm as the selected execution algorithm for use with the order. Alternatively, broker allocation system 118 determines at least one algorithm based on the order information and variables such as timing, price, or quantity of the order, and dynamically selects the execution algorithm based on these factors in response to predetermined settings which may be set by the user of client 102.

Broker allocation system 118 may then, at step 504, specify a weighting allocation for the order to at least one broker. Specifying the weighting allocation involves either receiving from a user of client 102, weightings representing portions of the order to be assigned to each respective broker, or automatically determining weighting allocations based on past orders, or prestored weighting allocations associated with a particular group of brokers.

At step 506, broker allocation system 118 allocates the order based on the weighting allocation and execution algorithm. This involves splitting the order into a plurality of child orders, wherein each child order is associated with a respective broker.

At step 508, the order is transmitted to brokers for execution. Transmitting the order to a broker for execution involves transmitting the order comprising a plurality of child orders to the at least one broker for execution. Each of the plurality of child orders is associated with a respective broker instructing the respective broker to execute a portion of the order based on the weighting allocation.

Alternatively, if an execution algorithm is not selected, the method proceeds directly from step 504, where a weighting allocation is specified for the order to at least one broker. Then, at step 506, the order is allocated based on the weighting allocation. At step 508, the order is transmitted to brokers for execution.

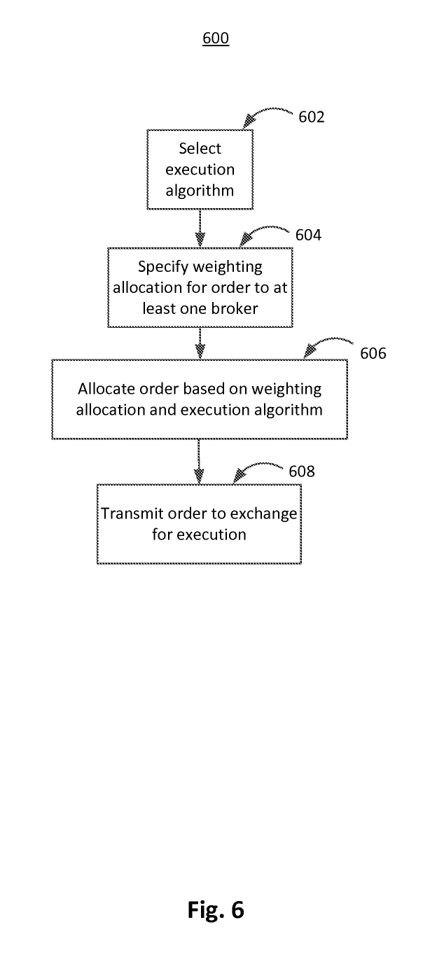

FIG. 6 illustrates another exemplary flow diagram showing an algorithm in accordance with the embodiments described herein. Method 600, as shown, illustrates an algorithm for transmitting a single order to an exchange with each broker member indicated in the order message for execution. In an embodiment, a broker allocation system, such as broker allocation system 118 selects an execution algorithm at step 602 based on user input received from a client 102 indicating an order for a trade. Selection of an execution algorithm includes determining at least one algorithm based on order information and variables such as timing, price, or quantity of the order. The algorithms may be provided in a list to a user of client 102 through a user interface provided by server 112. Upon receiving a selection of the execution algorithm from the list of algorithms from client 102, broker allocation system 118 then indicates or flags that execution algorithm as the selected execution algorithm for use with the order. Alternatively, broker allocation system 118 determines at least one algorithm based on the order information and variables such as timing, price, or quantity of the order, and dynamically selects the execution algorithm based on these factors in response to predetermined settings which may be set by the user of client 102.

Broker allocation system 118 may then, at step 604, specify a weighting allocation for the order to at least one broker. Specifying the weighting allocation involves either receiving from a user of client 102, weightings representing portions of the order to be assigned to each respective broker, or automatically determining weighting allocations based on past orders, or prestored weighting allocations associated with a particular group of brokers.

At step 606, broker allocation system 118 allocates the order based on the weighting allocation and execution algorithm. This involves splitting the order into a plurality of child orders, wherein each child order is associated with a respective broker.

At step 608, the order is transmitted to an exchange for execution. Transmitting the order to the exchange involves transmitting the order directly to the exchange for execution, where the order includes a message indicating each respective broker responsible for each child order, so that the client may thus execute, allocate and settle or pay commission directly with their broker after the exchange has processed the order. The order is transmitted on behalf of the brokers, where each child order dictates which broker is responsible for a portion of the order, thus allowing the client to execute, allocate and settle or pay commission directly with their broker after the exchange has processed the order.

Alternatively, if an execution algorithm is not selected, the method proceeds directly from step 604, where a weighting allocation is specified for the order to at least one broker. Then, at step 606, the order is allocated based on the weighting allocation. At step 608, the order is transmitted to the exchange for execution.

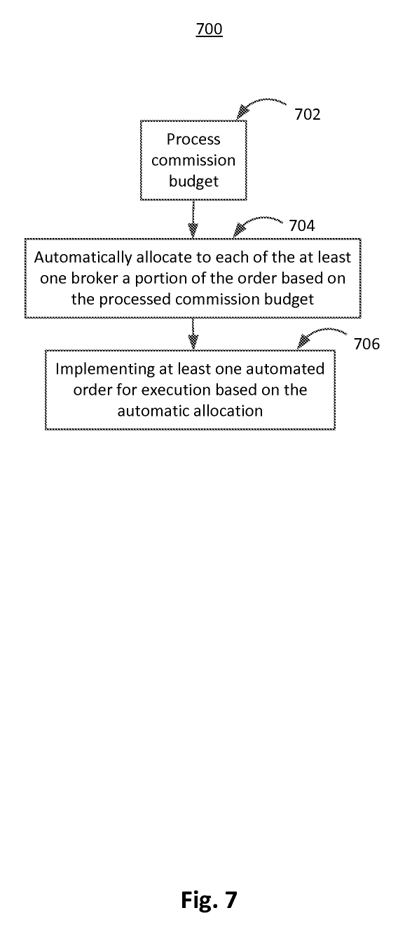

FIG. 7 illustrates another exemplary flow diagram showing an algorithm in accordance with the embodiments described herein. Method 700, as shown, illustrates an algorithm for implementing automated orders including child orders to multiple brokers based on a commission budget. At step 702, broker allocation system 118 may receive a commission budget from a user of client 102 over network 106. This commission budget represents a budget to be used on commissions for each of the brokers that will be executing an order placed by client 102. Broker allocation system 118 may process the commission budget in order to assign corresponding commission budgets to corresponding brokers selected by a user of client 102, as described herein.

Based on the processed commission budget, at step 704, broker allocation system 118 may automatically allocate to each of the at least one broker a portion of the order based on the processed commission budget.

At step 706, broker allocation system 118 may implement a procedure for carrying out at least one automated order for execution based on the automatic allocation in order for the orders to stay “on-track” and within the bounds of the commission budget provided by the user of client 102.

While method 700 is described with respect to utilizing a commission budget, it is understood that any other methodology which may be used to allocate orders to brokers may be utilized in place of a commission budget.

It shall be understood that each block of a flowchart illustration need not be limited in the ordering shown in the illustration, and might be performed in any ordering, or even performed concurrently, without departing from the spirit of the embodiments described herein. It will also be understood that each block of the flowchart illustration, and combinations of blocks in the flowchart illustration, can be implemented by execution of computer program instructions. These program instructions might be provided to a processor to produce a machine, such that the instructions, which execute on the processor, create means for implementing the actions specified in the flowchart block or blocks. The computer program instructions might be executed by a processor to cause a series of operational steps to be performed by the processor to produce a computer implemented process such that the instructions, which execute on the processor to provide steps for implementing the actions specified in the flowchart block or blocks.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

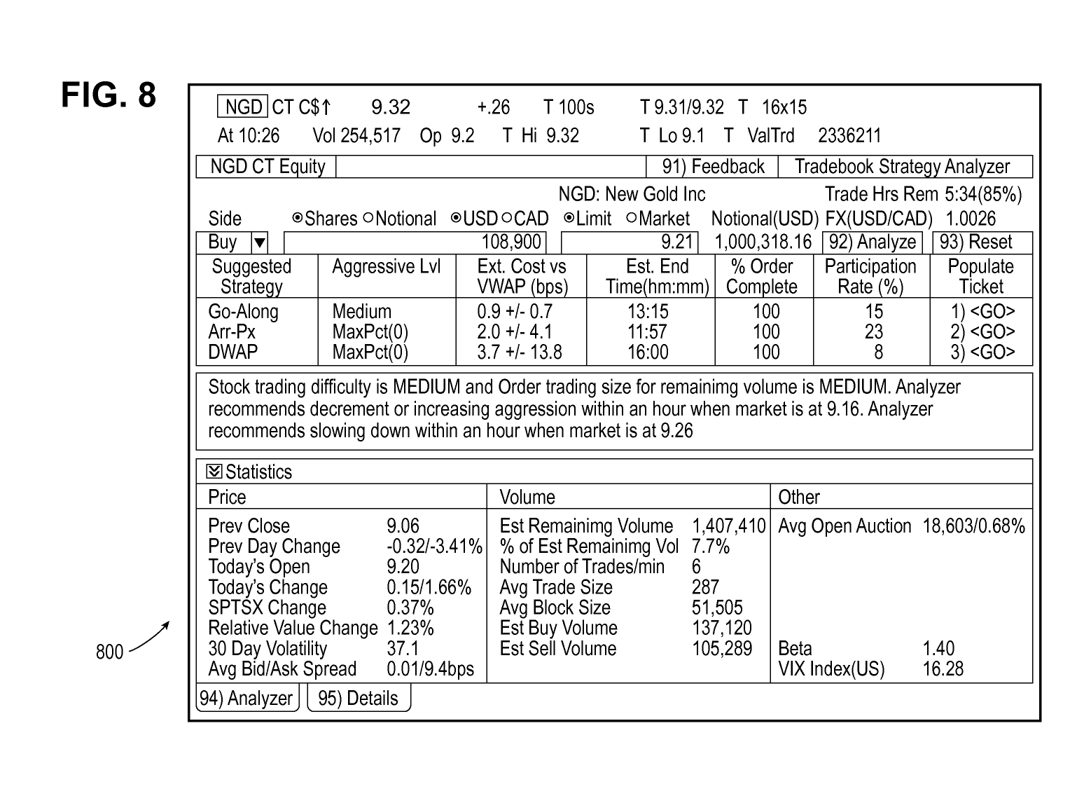

FIG. 8 illustrates an exemplary user interface for viewing analytics regarding a potential order in accordance with the embodiments described herein. Exemplary user interface 800, as shown, shows a user interface that may be used by a user to enter orders for execution by brokers. Upon entering the number of orders for a particular equity, for example, the user may be presented, through the user interface, with execution algorithms or strategies for executing the order, such as Go-Along, Arr-Px, and DWAP. Algorithms are shown based on factors including timing, price, or quantity of the order.

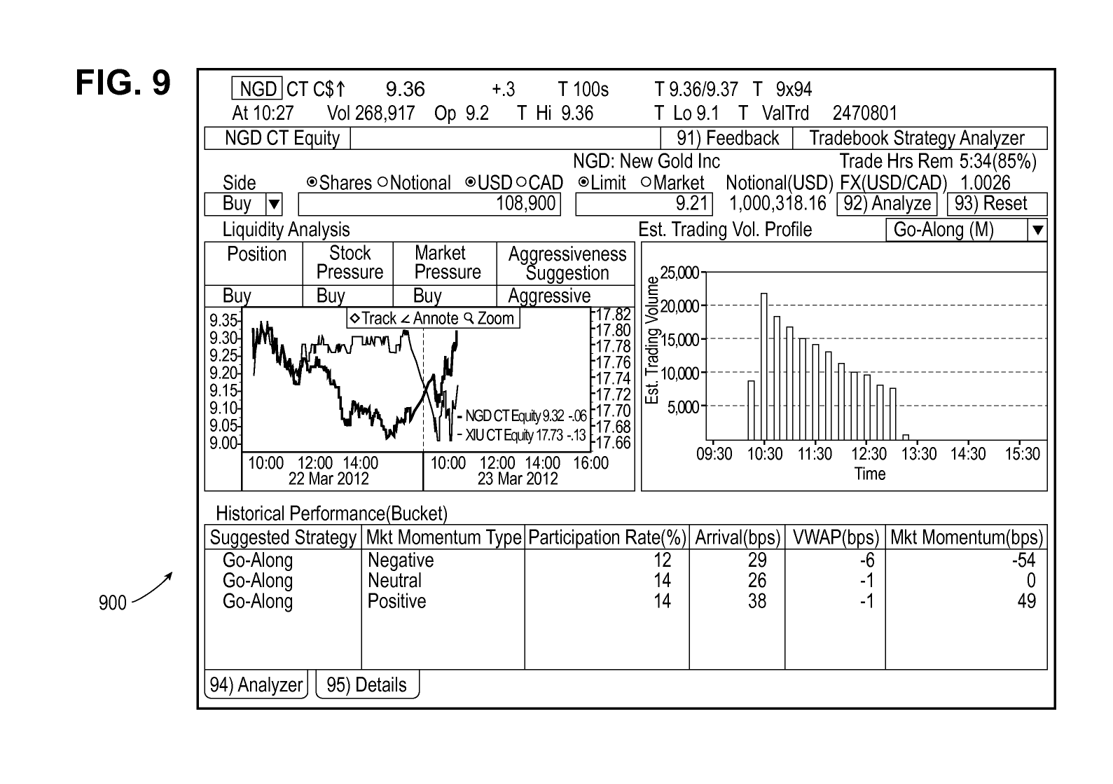

FIG. 9 illustrates another exemplary user interface for viewing analytics regarding a potential order in accordance with the embodiments described herein. Exemplary user interface 900, as shown, shows a user interface that may be used by a user to enter orders for execution by brokers. Analytic information may be provided along with suggestions for execution algorithms or strategies for executing the order.

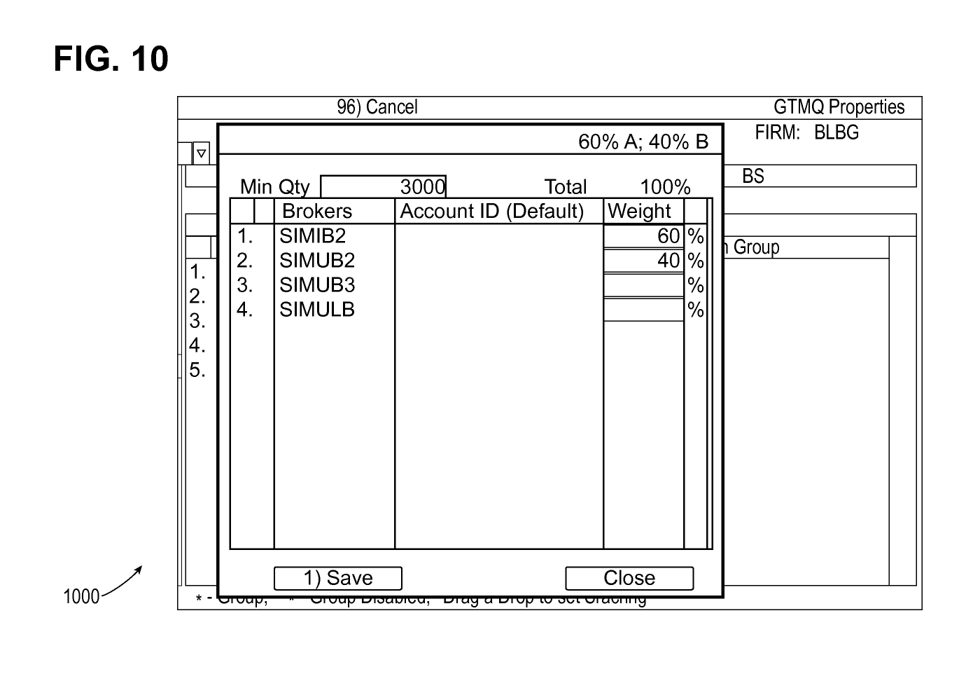

FIG. 10 illustrates another exemplary user interface for indicating weighting allocations for an order to different brokers in accordance with the embodiments described herein. Exemplary user interface 1000, as shown, shows an order quantity, as well as weightings assigned to two selected brokers: 60% assigned to SIMIB2 and 40% assigned to SIMUB2.

All systems and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

All systems and methods described herein may also be implemented using computers operating in a client-server relationship. Typically, in such a system, the client computer is located remotely from the server computer and interaction takes place via a network. The client-server relationship may be defined and controlled by computer programs executing on their respective client and server computers.

All systems and method described herein may also be used within a network-based cloud computing system. In such a network-based cloud computing system, a server or another processor that is connected to a network communicates with one or more client computers via a network. A client computer may communicate with the server via a network browser application residing and operating on the client computer, for example. A client computer may store data on the server and access the data via the network. A client computer may transmit requests for data, or requests for online services, to the server via the network. The server may perform requested services and provide data to the client computer(s). The server may also transmit data adapted to cause a client computer to perform a specified function, e.g., to perform a calculation, carry out an algorithm, to display specified data on a screen, etc. For example, the server may perform either at the server or cause a client to perform one or more of the method steps described herein, including at least the steps of FIGS. 5, 6, and 7. Certain steps of the method described herein may be performed by a server or by another processor in a network-based cloud-computing system. Certain steps of the methods described herein may be performed by a client computer in a network-based cloud computing system. The steps of the methods described herein may be performed by a server and/or by a client computer in a network-based cloud computing system, in any combination thereof.

All systems and methods described herein may be implemented using a computer program product tangibly embodied in an information carrier, e.g., in a non-transitory machine-readable storage, for execution by a programmable processor; and the method steps described herein may be implemented using one or more computer programs executable by such processor. A computer program may be a set of computer program instructions that can be used, directly or indirectly, by a computer to perform a certain activity or bring about a certain result. A computer program may be written in any form of programming language, including compiled or interpreted languages, and may be deployed in any form, including as a stand-alone program or as a module, component, subroutine, or other unit suitable for use in a computing environment.

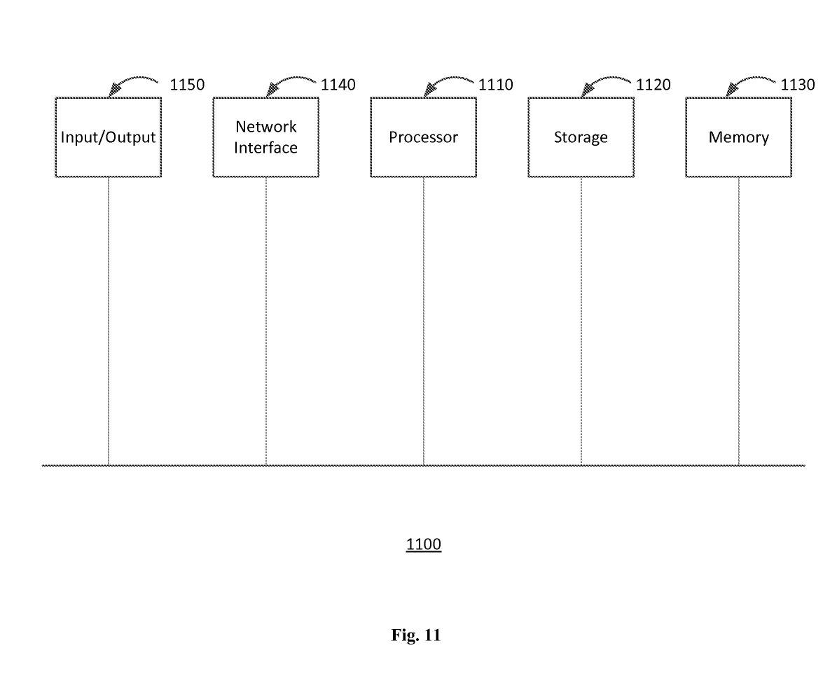

FIG. 11 illustrates a high-level diagram of a computing device that may be used to implement various aspects of the present disclosure. Computing device 1100 comprises a processor 1110 operatively coupled to a data storage device 1120 and a memory 1130. Processor 1110 controls the overall operation of computing device 1100 by executing computer program instructions that define such operations. The computer program instructions may be stored in data storage device 1120, or other computer readable mediums, and loaded into memory 1130 when execution of the computer program instructions is desired. Thus, at least the method steps of FIGS. 5, 6, and 7 can be defined by the computer program instructions stored in memory 1130 and/or data storage 1120 and controlled by processor 1110 executing the computer program instructions. For example, the computer program instructions can be implemented as computer executable code programmed by one skilled in the art to perform at least the algorithms defined by the method steps of FIGS. 5, 6, and 7. Computing device 1100 also includes one or more network interfaces for communicating with other devices via a network. Computing device 1100 also includes one or more input/output devices 1150 that enable user interaction with computing device 1100 (e.g., display, keyboard, mouse, speakers, buttons, etc.).

Processor 1110 may include both general and special purpose microprocessors, and may be the sole processor or one of multiple processors of computing device 1100. Processor 1110 may comprise one or more central processing units (CPUs), for example. Processor 1110, data storage device 1120, and/or memory 1130 may include, be supplemented by, or incorporated in, one or more application-specific integrated circuits (ASICs) and/or one or more field programmable gate arrays (FPGAs).

Data storage 1120 and memory 1130 each comprise a tangible non-transitory computer readable storage medium. Data storage 1120, and memory 1130, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 1150 may include peripherals, such as a printer, scanner, display screen, etc. For example, input/output devices 1150 may include a display device such as a cathode ray tube (CRT) or liquid crystal display (LCD) monitor for displaying information to the user, a keyboard, and a pointing device such as a mouse or a trackball by which the user can provide input to computing device 1100.

Any or all of the systems described herein, including clients 102, exchanges 104, broker/dealers 108, and server computers 112 may be implemented using computing device 800 or any equivalent device.

One skilled in the art will readily recognize that any implementation of an actual computer, computer system, or computing device may have other structures and may contain other components, and that computing device 1100 is merely a high level representation of some of the components for illustrative purposes.

The foregoing detailed description of the present disclosure is to be understood as being in every respect illustrative and exemplary, but not restrictive, and the scope of the present disclosure provided herein is not to be determined solely from the detailed description, but rather from the claims as interpreted according to the full breadth and scope permitted by patent laws. It is to be understood that the embodiments shown and described herein are merely illustrative of the principles addressed by the present disclosure and that various modifications may be implemented by those skilled in the art without departing from the scope and spirit of the present disclosure. Those skilled in the art may implement various other feature combinations without departing from the scope and spirit of the present disclosure. The various functional modules shown are for illustrative purposes only, and may be combined, rearranged and/or otherwise modified.

1. A non-transitory computer readable medium having executable code stored thereon, that when executed, causes a computing device to perform operations comprising:
selecting an execution algorithm for an order;
specifying a weighting allocation for the order to at least one broker;
allocating the order based on the weighting allocation and execution algorithm; and
transmitting the order for execution.

2. The non-transitory computer readable medium of claim 1, wherein the operation of selecting an execution algorithm for an order comprises:
determining at least one algorithm based on the order; and
receiving a selection of the execution algorithm from the at least one algorithm.

3. The non-transitory computer readable medium of claim 1, wherein the operation of selecting an execution algorithm for an order comprises:
determining at least one algorithm based on the order; and
dynamically selecting the execution algorithm from the at least one algorithm.

4. The non-transitory computer readable medium of claim 1, wherein the operation of allocating the order comprises:
splitting the order into a plurality of child orders, wherein each child order is associated with a respective broker.

5. The non-transitory computer readable medium of claim 1, wherein the operation of transmitting the order for execution comprises:
transmitting the order comprising a plurality of child orders to the at least one broker for execution, wherein each of the plurality of child orders is associated with a respective broker instructing the respective broker to execute a portion of the order based on the weighting allocation.

6. The non-transitory computer readable medium of claim 1, wherein the operation of transmitting the order for execution comprises:
transmitting the order comprising a plurality of child orders to an exchange for execution on behalf of each broker corresponding with a child order based on the weighting allocation.

7. The non-transitory computer readable medium of claim 1, wherein the operation of allocating the order comprises:
processing a commission budget;
automatically allocating to each of the at least one broker a portion of the order based on the processed commission budget; and
implementing at least one automated order for execution based on the automatic allocation.

8. A method for allocating order flow for trade execution, comprising:
selecting an execution algorithm for an order;
specifying a weighting allocation for the order to at least one broker;
allocating the order based on the weighting allocation and execution algorithm; and
transmitting the order for execution.

9. The method of claim 8, wherein selecting an execution algorithm for an order comprises:
determining at least one algorithm based on the order; and
receiving a selection of the execution algorithm from the at least one algorithm.

10. The method of claim 8, wherein selecting an execution algorithm for an order comprises:
determining at least one algorithm based on the order; and
dynamically selecting the execution algorithm from the at least one algorithm.

11. The method of claim 8, wherein allocating the order comprises:
splitting the order into a plurality of child orders, wherein each child order is associated with a respective broker.

12. The method of claim 8, wherein transmitting the order for execution comprises:
transmitting the order comprising a plurality of child orders to the at least one broker for execution, wherein each of the plurality of child orders is associated with a respective broker instructing the respective broker to execute a portion of the order based on the weighting allocation.

13. The method of claim 8, wherein the operation of transmitting the order for execution comprises:
transmitting the order comprising a plurality of child orders to an exchange for execution on behalf of each broker corresponding with a child order based on the weighting allocation.

14. A system comprising:
an allocation management module, coupled to a network, configured for:
selecting an execution algorithm for an order;
specifying a weighting allocation for the order to at least one broker; and
allocating the order based on the weighting allocation and execution algorithm;
and
a transmission unit, coupled to the allocation management module and the network, configured for:
transmitting the order for execution.

15. The system of claim 14, wherein the allocation management module is further configured for:
determining at least one algorithm based on the order; and
receiving a selection of the execution algorithm from the at least one algorithm.

16. The system of claim 14, wherein the allocation management module is further configured for:
determining at least one algorithm based on the order; and
dynamically selecting the execution algorithm from the at least one algorithm.

17. The system of claim 14, wherein the allocation management module is further configured for:
splitting the order into a plurality of child orders, wherein each child order is associated with a respective broker.

18. The system of claim 14, wherein the transmission unit is further configured for:
transmitting the order comprising a plurality of child orders to the at least one broker for execution, wherein each of the plurality of child orders is associated with a respective broker instructing the respective broker to execute a portion of the order based on the weighting allocation.

19. The system of claim 14, wherein the transmission unit is further configured for:
transmitting the order comprising a plurality of child orders to an exchange for execution on behalf of each broker corresponding with a child order based on the weighting allocation.

20. The system of claim 14, wherein the allocation management module is further configured for:
processing a commission budget;
automatically allocating to each of the at least one broker a portion of the order based on the processed commission budget; and
implementing at least one automated order for execution based on the automatic allocation.
